(19) United States
(12) Patent Application Publication
(10) Pub. No.: US 2026/0153440 A1
(43) Pub. Date: Jun. 4, 2026

(54) APPARATUS AND METHOD FOR MEASURING EXPONENTIALLY DECREASING AND INCREASING PROCESSES WITH COUNTING SYSTEMS WITH A RESTRICTED RANGE OF DYNAMICS

(71) Applicant: Fraunhofer-Gesellschaft zur Förderung der angewandten Forschung e.V., München (DE)

(72) Inventors: Jonas David ROTTMANN, Duisburg (DE); Justus Felix DUNG, Duisburg (DE); Manuel LIGGES, Duisburg (DE); Karsten SEIDL, Duisburg (DE); Nicolas Peter SCHIERBAUM, Duisburg (DE)

(73) Assignee: Fraunhofer-Gesellschaft zur Förderung der angewandten Forschung e.V., München (DE)

(21) Appl. No.: 19/406,980

(22) Filed: Dec. 3, 2025

(30) Foreign Application Priority Data
Dec. 3, 2024 (DE) 102024211539.8

(51) Int. Cl. G01N 21/64

(52) U.S. Cl. CPC G01N 21/6408; G01N 2021/641

(57) ABSTRACT

An apparatus for measuring an exponentially decreasing or an exponentially increasing process in accordance with an embodiment is provided, having a measuring window determining unit for determining a current measuring window, which defines a time range which is determined by from which first point in time on after exciting a signal source of a signal and up to which second point in time the signal is to be measured, further having a sensor for performing a current measurement of the signal precisely during the time range defined by the current measuring window, and an evaluating unit for determining a current measuring result of the current measurement. The measuring window determining unit is configured to determine the current measuring window in dependence on a previous measuring result of a previous measurement, the previous measurement having been performed precisely during a time range defined by a previous measuring window.

### CROSS-REFERENCE TO RELATED APPLICATION

This application claims priority from German Application No. 10 2024 211 539.8, which was filed on Dec. 3, 2024, and is incorporated herein by reference in its entirety.

### TECHNICAL FIELD

The application relates to an apparatus and a method for measuring exponentially decreasing and increasing processes with counting systems with a restricted range of dynamics.

### BACKGROUND OF THE INVENTION

Many natural processes, like fluorescence or semiconductor recombination, exhibit an exponential timeline. The time constant here is used as a measuring quantity, for example, when determining fluorophore, determining the quality of semiconductors and also when measuring chemical reaction rates. While the signal amplitude increases/decreases in a temporally exponential manner, the time constant, in the case of an ideal measurement without noise and saturation of the sensor, can be determined from the temporal change of the signal at any time of the signal. Thus, a time constant may, for example, be defined such that, in a monotonously decreasing exponential approximation, a time constant is understood to be the time period in which a quantity, like a count value, decreases to 1/e-fold of its value (approximately 37%).

In real measurements, however, in the case of small signal amplitudes, an imprecise determination of time constants results due to a low signal-to-noise ratio (SNR).

Due to the dead time of the sensor, an increasing number of results is not counted with an increasing signal amplitude. For example, in particle detectors or radiation detectors, a dead time may occur, wherein dead time here means the time period directly after detecting a particle where the sensor/detector is not yet ready again to detect/identify another particle. If a second particle arrives shortly after a first particle during the dead time, the second particle will not be identified by the sensor/detector.

With an increasing/high signal amplitude, the result is that the sensor is increasingly saturated and that the sensor response is non-linear. In exponential signals, the timeline of the saturation results in an underestimation of the time constants, which is also referred to as “pileup” effect. In order to establish the time constant with a maximum precision measurable, a signal amplitude, which offers a compromise between a high signal-to-noise ratio (SNR) and low sensor saturation is required.

### SUMMARY

An apparatus for measuring an exponentially decreasing process or an exponentially increasing process according to an embodiment is provided. The apparatus comprises a measuring window determining unit for determining a current measuring window, the current measuring window defining a time range, which is determined by from which first point in time on after exciting a signal source of a signal and up to which second point in time the signal is to be measured. Furthermore, the apparatus comprises a sensor for performing a current measurement of the signal precisely during the time range defined by the current measuring window. Additionally, the apparatus comprises an evaluating unit for determining a current measuring result of the current measurement. The measuring window determining unit is configured to determine the current measuring window in dependence on a previous measuring result of a previous measurement, the previous measurement having been performed precisely during a time range defined by a previous measuring window.

Furthermore, a method for measuring an exponentially decreasing process or an exponentially increasing process in accordance with an embodiment is provided. The method comprises:
Determining a current measuring window, the current measuring window defining a time range, which determines from which first point in time on after exciting a signal source of a signal and up to which second point in time the signal is to be measured.
Performing a current measurement of the signal precisely during the time range defined by the current measuring window. And:
Determining a current measuring result of the current measurement.

The current measuring window is determined in dependence on a previous measuring result of a previous measurement, the previous measurement having been performed precisely during a time range defined by a previous measuring window.

Additionally, a computer program in accordance with an embodiment comprising program code for performing the method described above is provided.

Embodiments provide a novel method for measuring exponential signals from an excited process with counting sensors with a restricted range of dynamics.

In order to establish the time constant with a certain precision in such signals, corresponding demands for the signal amplitude are entailed.

Embodiments are based on the finding that the precision of determining the time constant increases with an increasing signal amplitude due to an increasing signal-to-noise ratio (SNR) up to a maximum precision measurable. With a further increasing signal amplitude,

the precision decreases again since the sensor exhibits a non-linear behavior due to an increasing saturation. In the novel method presented here, due to a dynamic adjustment (or setting) of the measured signal amplitude during the measurement, the time constant is determined with the maximum precision measurable. Thus, the temporal distance between the signal excitation and the start of the next measuring window is varied on the basis of the count values of the sensor per measuring window and/or the timeline of the count values of a measuring window and the maximum possible count values of the sensor.

### BRIEF DESCRIPTION OF THE DRAWINGS

Embodiments of the invention will be described below referring to the appended drawings, in which:

FIG. 1 shows an apparatus for measuring an exponentially decreasing process or an exponentially increasing process in accordance with an embodiment.

FIG. 2 shows a schematic illustration of measuring an exponential decrease using the gated method by a linear temporal shift of a measuring window.

FIG. 3 shows a schematic illustration of a possible solution using the example of a temporally exponentially decreasing signal.

### DETAILED DESCRIPTION OF THE INVENTION

Before describing embodiments of the present invention below, background considerations are presented:

In order to establish the time constants with a certain precision, there have been both hardware-based and methodical possible solutions. The hardware-based approaches primarily relate to further developing sensors to increase their range of dynamics. Thus, in order to increase the precision of establishing the time constant, on the one hand, the noise level of the sensor can be reduced. On the other hand, the maximum linearly detectable signal of the signal can be increased. However, these approaches are complicated to realize and, due to technological restrictions, possible only to a limited extent (see [1], [2]).

In optical sensors, additionally the signal can be adjusted in dependence on its amplitude using the “reverse saturable absorber (RSA).” An increasing “pileup” effect with an increasing signal amplitude is avoided here, the absorption of the RSA increases with an increasing signal. The intensity-dependent absorption of RSAs, however, is strongly dependent on the wavelength and, also in small signal amplitudes, results in a reduction of the signal. Thus, with small signal amplitudes, the SNR is reduced further. This results in a lower precision when establishing the time constants (see [3]).

In methodical approaches, the most wide spread approach is based on adjusting amplification of the sensors. Here, the signal amplitude is approximated using previous measurements and, with small amplitudes, the amplification is increased or, with high signal amplitudes, the amplification is decreased. In this way, the signal amplitude is adjusted so as to establish the time constant with maximum precision. This can only be performed in the case of non-counting sensors. For example, the amplification of “photomultiplier tubes” and “avalanche photodiodes” can be adjusted via the supply voltage, whereas in the case of counting sensors, like “single photon avalanche diodes (SPADs)”, this is not possible due to the extremely high amplifications (see [4]).

It is also possible to achieve a certain precision when establishing the time constant by adjusting the excitation. Thus, due to the change in the excitation intensity, the exponential process is initiated to a differently strong degree and, consequently, adjusted in its signal amplitude. However, this method cannot be applied without any restrictions due to non-linearities of the excitation or the exponential process (see [5]).

A further approach for establishing the time constant with a certain precision is correcting non-linearities of the sensor in order to increase the range of linearity. Thus, the non-linearity of the sensor is measured using a reference system and, subsequently, taken into consideration when evaluating the measured signal. In this way, the range of linearity, however, can only be extended to a limited degree, since the sensor is less sensitive in the saturation range. Due to the restricted resolution and the noise of the sensor, the signal amplitude and, thus, with increasing signal amplitudes, the time constant can, despite corrections, be established only to a less precise degree (see [5], [6]).

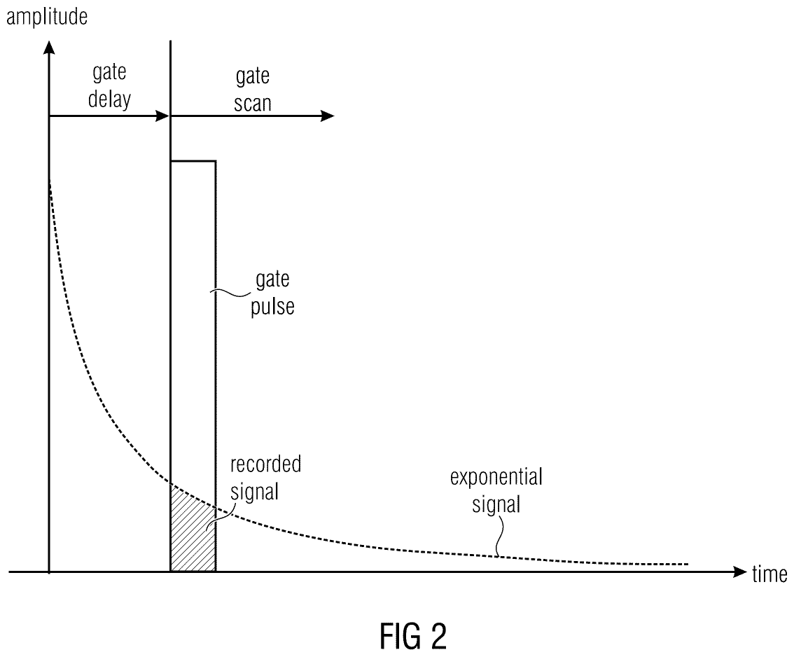

A further methodical approach for a time constant establishment of a certain precision is a ‘gated’ measurement with a temporally delayable measuring window. Here, not the entire exponential course in a measuring window is recorded and the time constant established therefrom. Instead, a temporal sub-range of the signal is measured using a defined measuring window. The measuring window is shifted in time by a delay unit so as to sample the signal and measure the exponential course (see FIG. 2). In this way, not the entire signal has to be within the linearity range of the sensor, but only that portion in the measuring window. Frequently, combination with an adjustment of the amplification for the individual delay points in time takes place. While this approach is similar to the embodiments presented below, no adjustment of the delay of the measuring window for excitation using the previous measurements takes place using the ‘gated’ method. Instead, there is a linear increase in the delay. Additionally, in the ‘gated’ measurement, usually it is not a temporal course that is determined, but only a count value for each delay point in time. Due to the linear shift of the measuring window, the ‘gated’ measurement entails high time requirements. In addition, despite the combination with the amplification adjustment, the result may be signal amplitudes outside the linearity range and, thus, an imprecise establishment of the time constants (see [4], [7]).

FIG. 2 shows a schematic illustration of measuring an exponential decrease using the ‘gated’ method by a linear time shift of a measuring window (in correspondence with [7]).

Embodiments of the present invention will be described below:

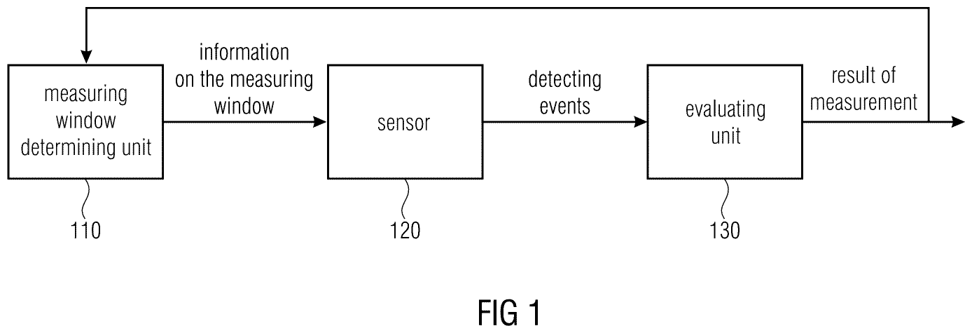

FIG. 1 shows an apparatus for measuring an exponentially decreasing process or an exponentially increasing process in accordance with an embodiment.

The apparatus comprises a measuring window determining unit 110 for determining a current measuring window, the current measuring window defining a time range, which is determined by from which first point in time on after exciting a signal source of a signal and up to which second point in time the signal is to be measured.

Furthermore, the apparatus comprises a sensor 120 for performing a current measurement of the signal precisely during the time range defined by the current measuring window.

Additionally, the apparatus comprises an evaluating unit 130 for determining a current measuring result of the current measurement. The measuring window determining unit 110 is configured to determine the current measuring window in dependence on a previous measuring result of a previous measurement, the previous measurement having been performed precisely during a time range defined by a previous measuring window.

In accordance with an embodiment, the measuring window determining unit 110 may, for example, be configured to determine the current measuring window in dependence on count values during the previous measurement in the previous measuring window, the count values indicating a number of events detected during the previous measurement in the previous measuring window.

In an embodiment, the measuring window determining unit 110 may, for example, be configured to determine the current measuring window in dependence on a timeline of the count values of the previous measurement during the previous measuring window, the timeline of the count values indicating a timeline of the events detected during the previous measurement in the previous measuring window.

In accordance with an embodiment, the measuring window determining unit 110 may, for example, be configured to determine the current measuring window by the measuring window determining unit 110 determining a time delay between excitation of a signal source of the signal and the current measuring window.

In an embodiment, the measuring window determining unit 110 may, for example, be configured to determine the current measuring window by the measuring window determining unit 110 determining a time delay between excitation of a signal source of the signal and the first point in time, which indicates the start of the current measuring window.

In accordance with an embodiment, the measuring window determining unit 110 may, for example, be configured to determine the current measuring window by the measuring window determining unit 110 determining a time delay between excitation of a signal source of the signal and the second point in time, which indicates the end of the current measuring window.

In an embodiment, the measuring window determining unit 110 may, for example, be configured to determine the current measuring window in dependence on count values during the previous measurement in the previous time window, the count values indicating a number of events detected during the previous measurement in the previous measuring window. Thus, the measuring window determining unit 110 may, for example, be configured to increase the time delay between excitation of a signal source of the signal and the current measuring window relative to the time delay between excitation of the signal source of the signal and the previous measuring window if the number of the count values of the previous measurement in the previous measuring window is greater than a reference value. Furthermore, the measuring window determining unit 110 may, for example, be configured to decrease the time delay between excitation of the signal source of the signal and the current measuring window relative to the time delay between excitation of a signal source of the signal and the previous measuring window if the number of count values of the previous measurement in the previous measuring window is smaller than the reference value.

If, for example, the number of count values is smaller than the reference value, the following may apply: v_{cur}=c1*vₚᵣₑ with 0<c1<1, wherein v_{cur} is the current time delay and wherein vₚᵣₑ is the previous time delay.

Additionally, if, for example, the number of count values is greater than the reference value, the following may apply: v_{cur}=c2*vₚᵣₑ with 1<c2<2, wherein v_{cur} is the current time delay and wherein vₚᵣₑ is the previous time delay.

c1 and c2 may, for example, be pre-defined real numerical values in the range of numbers defined above.

For example, it may additionally be provided for measurements to be performed repeatedly, wherein with an increasing number of measurements, c1 increases, c2 decreases and both iterate towards 1.

In accordance with an embodiment, the measuring window determining unit 110 may, for example, be configured to determine the current measuring window in dependence on a timeline of the count values of the previous measurement during the previous measuring window, the timeline of the count values indicating a timeline of the events detected during the previous measurement in the previous measuring window. Thus, the measuring window determining unit 110 may be configured to increase the time delay between excitation of a signal source of the signal and the current measuring window relative to the time delay between excitation of the signal source of the signal and the previous measuring window if, in a first signal portion, at the beginning of the previous measuring window, more count values than a first threshold value were detected. Additionally, the measuring window determining unit 110 may, for example, be configured to decrease the time delay between excitation of the signal source of the signal and the current measuring window relative to the time delay between excitation of the signal source of the signal and the previous measuring window if, in a last signal portion, at the end of the previous measuring window, fewer count values than a second threshold value were detected.

In an embodiment, the evaluating unit 130 may, for example, be configured to determine the current measuring result of the current measurement by the evaluating unit 130 determining count values during the current measurement in the current measuring window, the count values indicating a number of events detected during the current measurement in the current measuring window. And/or the evaluating unit 130 may, for example, be configured to determine the current measuring result of the current measurement by the evaluating unit 130 determining a timeline of the count values of the current measurement during the current measuring window, the timeline of the count values indicating a timeline of the events detected during the current measurement in the current measuring window.

In accordance with an embodiment, the sensor 120 may, for example, be configured to perform the previous measurement in the previous measuring window.

In an embodiment, the sensor 120 may, for example, be configured to perform at least one further measurement after performing the current measurement. Thus, the measuring window determining unit 110 may, for example, be configured to determine, for performing the at least one further measurement, at least one further measuring window in dependence on the current measuring result of the current measurement.

In accordance with an embodiment, the current measurement and the previous measurement may, for example, be a measurement of an exponentially decreasing physical or chemical or electrical process and/or an exponentially increasing physical or chemical or electrical process.

In an embodiment, the current measurement and the previous measurement may, for example, be a measurement of a physical or chemical decay process.

In an embodiment, the current measurement and the previous measurement may, for example, be a measurement of a fluorescence lifetime.

Specific embodiments of the invention will be illustrated below:

In order to establish the time constant with a certain precision, according to embodiments of the invention, the signal amplitude is, for example, varied by a dynamic time delay between excitation of the signal source and the measuring window.

Here, at least one measurement is used to evaluate the signal, for example, using the count values per measuring window and/or, for example, using the timeline of the count values. The evaluation may, for example, take place while considering the maximum count values per measuring window of the sensor 120.

Based on this evaluation, the time delay of the excitation of the signal source and the measuring window for subsequent measurements is varied in order to optimize the signal amplitude for a time constant establishment of a certain precision.

With a decreased precision due to the ‘Pileup’ effect with high signal amplitudes, the time delay between excitation and measuring window is increased. With a decreased precision due to a low SNR in the case of small signal amplitudes, the time delay is decreased up to a minimum, where the measuring window follows after the excitation without any time offset.

With a time constant establishment of a certain precision by a corresponding signal amplitude, the delay is not adjusted. Adjusting the delay is done continuously for the further measurements using the previous measurement(s). In this way, the signal amplitude is adjusted dynamically and, with a sufficient signal, corresponds to the desired criterion for the precise time constant establishment.

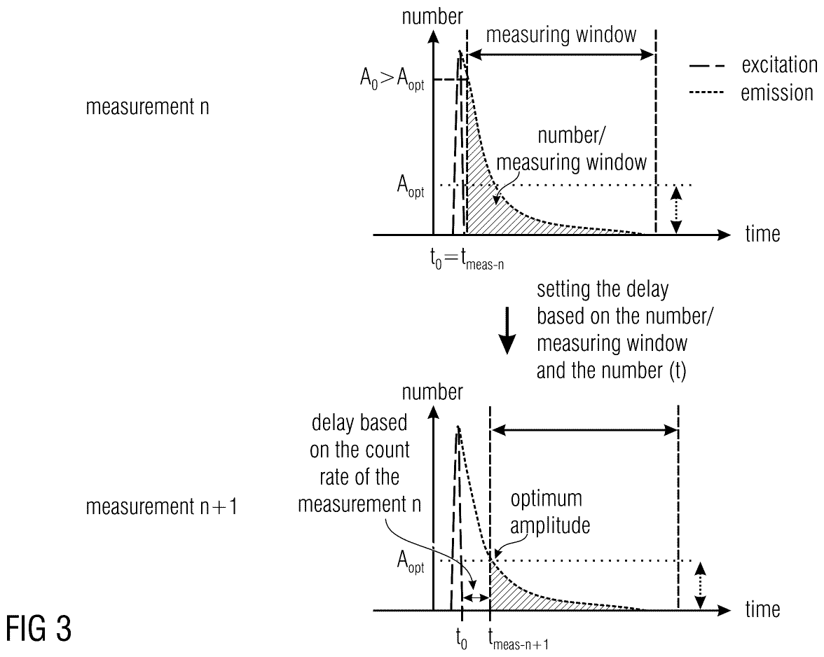

FIG. 3 shows a schematic illustration of the solution approach using the example of a temporally exponentially decreasing signal.

In the embodiments presented here, when compared to the “gated” method, a measuring window which, in a temporally resolved manner, measures a sufficient part of the exponential course is shifted so as to subsequently establish the time constant.

Additionally, when compared to the “gated” method, the shift is not performed linearly, but using the count values per measurement value and/or the timeline of the count values. By dynamically adjusting the signal amplitude on the basis of the previous measurements using the solution presented, however, considerably smaller measuring times can be achieved, for a time constant establishment of a certain precision than is the case in the “gated” method.

Embodiments of the invention may, for example, be applied when a repetitive measurement of time constants of exponential processes takes place.

An application of embodiments is measuring the time constants of fluorescence processes (fluorescence lifetimes). This is, for example, employed in microscopy, wherein the time constant of the exponential decrease of the intensity of fluorescence is established in different optical pixels of an array and a “chemically-resolved” image of the sample material is generated therefrom. Thus, the fluorescence signal may, in dependence on the examined medium, impinge on different pixels with different signal amplitudes, which results in an imprecise fluorescence lifetime determination of the pixels and, consequently, a faulty image. Using the method presented, the precision can be maintained for all the pixels by adjusting the time delay between excitation and measuring window in a pixel-dependent manner. In video microscopy, the fluorescence intensity and, consequently, the signal amplitude may vary in time, for example due to living or reagent samples. The signal amplitude may still be optimized over time by the dynamic delay of the method and, consequently, the fluorescence lifetime can be determined precisely.

Another application of embodiments of the invention is, for example, when determining fluorescence lifetimes by means of flow-through cytometry. Here, cells marked with fluorophores are measured when flowing through, wherein the cells may exhibit different signal amplitudes due to a differently strong coloration and only a small measurement time per cell is available due to the flow-through. By the novel and quick method, the signal amplitude can be optimized for each cell individually using the delay in order to measure the time constant of all the cell markings with a certain precision.

The method described allows measuring the time constants of exponential signals of a process excited with counting sensors 120 with a restricted range of dynamics at a certain precision. In order to achieve the precision, the signal amplitude is adjusted dynamically for a compromise between a high SNR and a low “pileup” effect by a delay between excitation of the signal and measuring window. The delay may be realized by electrically controlling the excitation and the measuring window. Due to the high velocity of electrical switching processes, the delay can be adjusted precisely, thereby measuring the time constant in the method presented in an extremely quick and precise manner. Consequently, embodiments of the invention may also be applied to highly dynamic processes.

Embodiments of the invention provide for a dynamic delay between excitation and measuring window in dependence on the signal amplitude. In embodiments, the time delay between excitation and the measuring window is determined.

Although some aspects have been described in connection with an apparatus, it is to be understood that these aspects also represent a description of the corresponding method, with the result that a block or a component of an apparatus is also to be understood as a corresponding method step or feature of a method step. In analogy, aspects described in connection with or as a method step also represent a description of a corresponding block or detail or feature of a corresponding apparatus. Some or all of the method steps may be performed by a hardware apparatus (or using a hardware apparatus), like a microprocessor, a programmable computer or an electronic circuit. In some embodiments, some or more of the most important method steps may be performed by such an apparatus.

Depending on specific implementation requirements, embodiments of the invention may be implemented in hardware or in software or at least partly in hardware or at least partly in software. The implementation can be carried out using a digital storage medium, for example a floppy disk, a DVD, a Blu-ray disc, a CD, ROM, PROM, EPROM, EEPROM or a FLASH memory, a hard disk or another magnetic or optical memory, on which electronically readable control signals are stored which can interact or interact with a programmable computer system such that the respective method is performed. The digital storage medium can therefore be computer-readable.

Thus, some embodiments according to the invention comprise a data carrier which has electronically readable control signals which are capable of interacting with a programmable computer system such that one of the methods described herein is performed.

In general, embodiments of the present invention can be implemented as a computer program product with program code, wherein the program code is effective to perform one of the methods when the computer program product runs on a computer.

The program code may, for example, also be stored on a machine-readable carrier.

Other embodiments comprise the computer program for performing one of the methods described herein, wherein the computer program is stored on a machine-readable carrier. In other words, an embodiment of the method according to the invention is thus a computer program which has program code for performing one of the methods described herein when the computer program runs on a computer.

A further embodiment of the methods according to the invention is thus a data carrier (or a digital storage medium or a computer-readable medium) on which the computer program for performing one of the methods described herein is recorded. The data carrier or the digital storage medium or the computer-readable medium is typically tangible and/or non-volatile.

A further embodiment of the method according to the invention is thus a data stream or a sequence of signals which represents or represent the computer program for performing one of the methods described herein. The data stream or the sequence of signals can, for example, be configured to be transferred via a data communication link, for example via the Internet.

A further embodiment comprises a processing device, for example a computer or a programmable logic component, which is configured or adjusted to perform one of the methods described herein.

A further embodiment comprises a computer on which the computer program for performing one of the methods described herein is installed.

A further embodiment according to the invention comprises an apparatus or a system configured to transfer a computer program for performing at least one of the methods described herein to a receiver. The transfer may, for example, be done electronically or optically. The receiver may, for example, be a computer, mobile device, memory device or a similar apparatus. The apparatus or the system may, for example, comprise a file server for transferring the computer program to the receiver.

In some embodiments, a programmable logic device (for example a field-programmable gate array, FPGA) can be used to perform some or all of the functionalities of the methods described herein. In some embodiments, a field-programmable gate array can interact with a microprocessor to perform any of the methods described herein. Generally, in some embodiments, the methods are performed by any hardware apparatus. This can be universally usable hardware such as a computer processor (CPU) or hardware specific to the method, for example an ASIC.

While this invention has been described in terms of several embodiments, there are alterations, permutations, and equivalents which fall within the scope of this invention. It should also be noted that there are many alternative ways of implementing the methods and compositions of the present invention. It is therefore intended that the following appended claims be interpreted as including all such alterations, permutations and equivalents as fall within the true spirit and scope of the present invention.

### Literature

[1] A. C. Ulku et al., “A 512×512 SPAD Image Sensor with Integrated Gating for Widefield FLIM,” IEEE journal of selected topics in quantum electronics: a publication of the IEEE Lasers and Electro-optics Society, Early Access. doi: 10.1109/JSTQE.2018.2867439.
[2] F. Ceccarelli, G. Acconcia, I. Labanca, A. Gulinatti, M. Ghioni und I. Rech, “152-dB Dynamic Range With a Large-Area Custom-Technology Single-Photon Avalanche Diode,” IEEE Photon. Technol. Lett., Y. 30, No. 4, pp. 391-394, 2018, doi: 10.1109/LPT.2018.2792781.
[3] Y. B. Band, “Optical Properties and Applications of Reverse Saturable Absorbers,” in Methods of Laser Spectroscopy, Y. Prior, A. Ben-Reuven und M. Rosenbluh, Hg., Boston, MA: Springer US, 1986, pp. 117-121.
[4] A. Tosi et al., “Fast-gated single-photon counting technique widens dynamic range and speeds up acquisition time in time-resolved measurements,” Opt. Express, OE, Y. 19, No. 11, pp. 10735-10746, 2011. doi: 10.1364/OE.19.010735. [Online]. Verfügbar unter: https://opg.optica.org/oe/fulltext.cfm?uri=oe-19-11-10735&id=214120
[5] V. J. Kitsmiller, C. Campbell und T. D. O′Sullivan, “Optimizing sensitivity and dynamic range of silicon photomultipliers for frequency-domain near infrared spectroscopy,” Biomedical optics express, Early Access. doi: 10.1364/BOE.401439.
[6] J. Ogi et al., “A 124-dB Dynamic-Range SPAD Photon-Counting Image Sensor Using Subframe Sampling and Extrapolating Photon Count,” IEEE J. Solid-State Circuits, Y. 56, No. 11, pp. 3220-3227, 2021, doi: 10.1109/JSSC.2021.3114620.
[7] W. Becker, “Fluorescence lifetime imaging—techniques and applications,” Journal of microscopy, Early Access. doi: 10.1111/j.1365-2818.2012.03618.x.

1. An apparatus for measuring an exponentially decreasing process or an exponentially increasing process, the apparatus comprising:
a measuring window determining unit for determining a current measuring window, the current measuring window defining a time range which is determined by from which first point in time on after exciting a signal source of a signal and up to which second point in time the signal is to be measured,
a sensor for performing a current measurement of the signal precisely during the time range defined by the current measuring window, and
an evaluating unit for determining a current measuring result of the current measurement,
wherein the measuring window determining unit is configured to determine the current measuring window in dependence on a previous measuring result of a previous measurement, the previous measurement having been performed precisely during a time range defined by a previous measuring window.

2. The apparatus in accordance with claim 1,
wherein the measuring window determining unit is configured to determine the current measuring window in dependence on count values during the previous measurement in the previous measuring window, the count values indicating a number of events detected during the previous measurement in the previous measuring window.

3. The apparatus in accordance with claim 1,
wherein the measuring window determining unit is configured to determine the current measuring window in dependence on a timeline of the count values of the previous measurement during the previous measuring window, the timeline of the count values indicating a timeline of the events detected during the previous measurement in the previous measuring window.

4. The apparatus in accordance with claim 1,
wherein the measuring window determining unit is configured to determine the current measuring window by the measuring window determining unit determining a time delay between excitation of a signal source of the signal and the current measuring window.

5. The method in accordance with claim 4,
wherein the measuring window determining unit is configured to determine the current measuring window by the measuring window determining unit determining a time delay between excitation of a signal source of the signal and the first point in time which indicates a start of the current measuring window.

6. The apparatus in accordance with claim 4,
wherein the measuring window determining unit is configured to determine the current measuring window by the measuring window determining unit determining a time delay between excitation of a signal source of the signal and the second point in time which indicates an end of the current measuring window.

7. The apparatus in accordance with claim 4,
wherein the measuring window determining unit is configured to determine the current measuring window in dependence on count values during the previous measurement in the previous measuring window, the count values indicating a number of events detected during the previous measurement in the previous measuring window,
wherein the measuring window determining unit is configured to increase the time delay between excitation of a signal source of the signal and the current measuring window relative to the time delay between excitation of the signal source of the signal and the previous measuring window if the number of count values of the previous measurement in the previous measuring window is greater than a reference value, and
wherein the measuring window determining unit is configured to decrease the time delay between excitation of the signal source of the signal and the current measuring window relative to the time delay between excitation of a signal source of the signal and the previous measuring window if the number of count values of the previous measurement in the previous measuring window is smaller than the reference value.

8. The apparatus in accordance with claim 4,
wherein the measuring window determining unit is configured to determine the current measuring window depending on a timeline of the count values of the previous measurement during the previous measuring window, the timeline of the count values indicating a timeline of the events detected during the previous measurement in the previous measuring window,
wherein the measuring window determining unit is configured to increase the time delay between excitation of a signal source of the signal and the current measuring window relative to the time delay between excitation of the signal source of the signal and the previous measuring window if, in a first signal portion at the beginning of the previous measuring window, more count values than a first threshold value were detected, and
wherein the measuring window determining unit is configured to decrease the time delay between excitation of the signal source of the signal and the current measuring window relative to the time delay between excitation of the signal source of the signal and the previous measuring window if, in a last signal portion at the end of the previous measuring window, fewer count values than a second threshold value were detected.

9. The apparatus in accordance with claim 1,
wherein the evaluating unit is configured to determine the current measuring result of the current measurement by the evaluating unit determining count values during the current measurement in the current measuring window, the count values indicating a number of results detected during the current measurement in the current measuring window; and/or
wherein the evaluating unit is configured to determine the current measuring result of the current measurement by the evaluating unit determining a timeline of the count values of the current measurement during the current measuring window, the timeline of the count values indicating a timeline of the events detected during the current measurement in the current measuring window.

10. The apparatus in accordance with claim 1,
wherein the sensor is configured to perform the previous measurement in the previous measuring window.

11. The apparatus in accordance with claim 1,
wherein the sensor is configured to perform at least one further measurement after performing the current measurement,
wherein the measuring window determining unit is configured to determine, for performing the at least one further measurement, at least one further measuring window in dependence on the current measuring result of the current measurement.

12. The apparatus in accordance with claim 1,
wherein the current measurement and the previous measurement are measurements of an exponentially decreasing physical or chemical or electrical process and/or of an exponentially increasing physical or chemical or electrical process.

13. The apparatus in accordance with claim 1,
wherein the current measurement and the previous measurement are measurements of a physical or chemical decay process, for example, a measurement of a fluorescence lifetime.

14. A method for measuring an exponentially decreasing process or an exponentially
increasing process, the method comprising;
determining a current measuring window, the current measuring window defining a time range, which is determined by from which first point in time on after exciting of a signal source of a signal and up to which second point in time the signal is to be measured,
performing a current measurement of the signal precisely during the time range defined by the current measuring window, and
determining a current measuring result of the current measurement,
wherein the current measuring window is determined in dependence on a previous measuring result of a previous measurement, the previous measurement having been performed precisely during a time range defined by a previous measuring window.

15. A non-transitory computer-readable medium comprising a computer program for implementing the method for measuring an exponentially decreasing process or an exponentially increasing process in accordance with claim 14 when the method is implemented by a computer of signal processor.
